(19) United States
(12) Patent Application Publication
(10) Pub. No.: US 2026/0309921 A1
(43) Pub. Date: Oct. 8, 2026

(54) OPTICAL FIBER CUTTING DEVICE

(71) Applicant: Fujikura Ltd., Tokyo (JP)

(72) Inventors: Shuta Sagae, Sakura-shi, Chiba (JP); Makoto Iwamatsu, Sakura-shi, Chiba (JP)

(73) Assignee: Fujikura Ltd., Tokyo (JP)

(21) Appl. No.: 19/482,296

(22) PCT Filed: Jun. 27, 2024
(86) PCT No.: PCT/JP2024/023388

§ 371 Date: Nov. 7, 2025

(30) Foreign Application Priority Data
Jun. 27, 2023 (JP) 2023-104994

(51) Int. Cl. G02B 6/25

(52) U.S. Cl. CPC G02B 6/25

(57) ABSTRACT

An optical fiber cutting device includes a pedestal part on which a fiber holder holding an optical fiber is disposed and a main body part including a scratching blade that scratches the optical fiber, a first attaching portion to which the pedestal part is attached, and a second attaching portion to which the pedestal part is attached. When the scratching blade is positioned to scratch the optical fiber, the first attaching portion and the second attaching portion are positioned on opposite sides from each other with respect to the scratching blade and the first attaching portion, the scratching blade, and the second attaching portion are arranged in a specific direction.

### CROSS-REFERENCE TO RELATED APPLICATIONS

The present application is a national phase application of International Application No. PCT/JP2024/023388, filed Jun. 27, 2024, which claims priority to Japanese Patent Application No. 2023-104994, filed Jun. 27, 2023. The contents of these applications are incorporated herein by reference in their entirety.

### BACKGROUND

### Technical Field

The present invention relates to an optical fiber cutting device.

### Discussion of the Background

Patent Document 1 discloses an optical fiber cutting device including a main body part provided with a scratching blade for scratching an optical fiber, a fiber holder holding the optical fiber, and a lid connected to the main body part to be openable and closable. A user grips the optical fiber to be cut with one hand and sets the gripped optical fiber in the fiber holder. Thereafter, the optical fiber is pressed against the scratching blade by closing the lid with the other hand. Thereby, the optical fiber is scratched and cut.

### Patent Literature

Patent Document 1: Japanese Patent Publication No. 2015-141304

In the optical fiber cutting device of Patent Document 1, the fiber holder is fixed to a right side of the scratching blade. Therefore, there have been cases in which an operation thereof is difficult to perform depending on a user's dominant hand, resulting in poor usability of the optical fiber cutting device.

### SUMMARY

One or more embodiments provide an optical fiber cutting device with improved usability.

An optical fiber cutting device according to aspect 1 of one or more embodiments includes a pedestal part on which a fiber holder holding an optical fiber is placeable, and a main body part including a scratching blade scratching the optical fiber, in which the main body part includes a first attaching portion and a second attaching portion to which the pedestal part is attachable, and, in a state in which the scratching blade is at a position to scratch the optical fiber, the first attaching portion and the second attaching portion are positioned on opposite sides from each other with respect to the scratching blade, and the first attaching portion, the scratching blade, and the second attaching portion are arranged in one direction (a specific direction).

According to aspect 1 of one or more embodiments, it is possible to improve usability of the optical fiber cutting device.

Also, according to aspect 2 of one or more embodiments, in the optical fiber cutting device of aspect 1, the pedestal part may have a placement surface on which the fiber holder is placed, the main body part may include a clamp clamping the optical fiber, the clamp may have a clamping surface supporting the clamped optical fiber, and the placement surface when the pedestal part is attached to the first attaching portion and the placement surface when the pedestal part which has been attached to the first attaching portion is attached to the second attaching portion may be substantially parallel to the clamping surface, and a distance between the placement surface and the clamping surface when the pedestal part is attached to the first attaching portion may be substantially equal to a distance between the placement surface and the clamping surface when the pedestal part which has been attached to the first attaching portion is attached to the second attaching portion.

According to aspect 2 of one or more embodiments, in either case in which the pedestal part is attached to the first attaching portion or the second attaching portion, it is possible to easily make the placement surface and the clamping surface parallel.

Also, according to aspect 3 of one or more embodiments, in the optical fiber cutting device of aspect 2, the pedestal part may have a first positioning surface parallel to the placement surface, the first attaching portion may have a first attaching portion surface parallel to the first positioning surface, the second attaching portion may have a second attaching portion surface parallel to the first positioning surface, the first positioning surface and the first attaching portion surface may be in surface contact when the pedestal part is attached to the first attaching portion, and the first positioning surface and the second attaching portion surface may be in surface contact when the pedestal part is attached to the second attaching portion.

According to aspect 3 of one or more embodiments, it is possible to perform positioning between the placement surface and the clamping surface more easily.

Also, according to aspect 4 of one or more embodiments, in the optical fiber cutting device of aspect 3, the pedestal part may include a first pressing part pressing the first positioning surface against the first attaching portion surface or the second attaching portion surface when the pedestal part is attached to the first attaching portion or the second attaching portion.

According to aspect 4 of one or more embodiments, it is possible to further improve a positioning accuracy of the placement surface with respect to the clamping surface.

Also, according to aspect 5 of one or more embodiments, in the optical fiber cutting device of aspect 3 or 4, the pedestal part may have two or more first positioning surfaces.

According to aspect 5 of one or more embodiments, the positioning accuracy of the placement surface with respect to the clamping surface can be even further improved.

Also, according to aspect 6 of one or more embodiments, in the optical fiber cutting device of aspect 5, the pedestal part may include a first side edge portion positioned on one side in a cross direction intersecting a direction in which the pedestal part is attached to the first attaching portion or the second attaching portion, and a second side edge portion positioned on a side opposite to the first side edge portion in the cross direction, and the pedestal part may have the first positioning surface provided on the first side edge portion, and the first positioning surface provided on the second side edge portion.

According to aspect 6 of one or more embodiments, it is possible to further improve the positioning accuracy of the placement surface.

Also, according to aspect 7 of one or more embodiments, in the optical fiber cutting device of aspect 1, the pedestal part may have a placement surface on which the fiber holder is placeable, the pedestal part may include a protruding portion protruding in a first direction or a second direction, the first direction being a direction parallel to the placement surface among attaching directions in which the pedestal part is attached to the first attaching portion or the second attaching portion and a second direction being a direction intersecting the placement surface among the attaching directions, the first attaching portion may have a first fitting recessed portion into which the protruding portion is fitted when the pedestal part is attached, and the second attaching portion may have a second fitting recessed portion into which the protruding portion is fitted when the pedestal part is attached.

According to aspect 7 of one or more embodiments, it is possible to easily perform positioning of the placement surface in the cross direction.

Also, according to aspect 8 of one or more embodiments, in the optical fiber cutting device of any one of aspects 2 to 6, the pedestal part may include a protruding portion protruding in a first direction or a second direction, the first direction being a direction parallel to the placement surface among attaching directions in which the pedestal part is attached to the first attaching portion or the second attaching portion and a second direction being a direction intersecting the placement surface among the attaching directions, the first attaching portion may have a first fitting recessed portion into which the protruding portion is fitted when the pedestal part is attached, and the second attaching portion may have a second fitting recessed portion into which the protruding portion is fitted when the pedestal part is attached.

According to aspect 8 of one or more embodiments, it is possible to easily perform positioning of the placement surface in the cross direction.

Also, according to aspect 9 of one or more embodiments, in the optical fiber cutting device of aspect 7 or 8, a cross-sectional shape of the protruding portion perpendicular to the first direction may be a circular shape, and a cross-sectional shape of the first fitting recessed portion or the second fitting recessed portion perpendicular to the first direction may be an oval shape with a major axis thereof extending in a direction intersecting the placement surface.

According to aspect 9 of one or more embodiments, it is possible to suppress a decrease in positioning accuracy of the placement surface with respect to the clamping surface.

Also, according to aspect 10 of one or more embodiments, in the optical fiber cutting device of any one of aspects 1 to 9, the pedestal part may have a second positioning surface intersecting a first direction which is a direction parallel to the placement surface among attach directions in which the pedestal part is attached to the first attaching portion or the second attaching portion, the first attaching portion may have a first attaching portion side surface which is in surface contact with the second positioning surface when the pedestal part is attached, and the second attaching portion may have a second attaching portion side surface which is in surface contact with the second positioning surface when the pedestal part is attached.

According to aspect 10 of one or more embodiments, it is possible to perform positioning between the placement surface and the scratching blade in the first direction.

Also, according to aspect 11 of one or more embodiments, in the optical fiber cutting device of aspect 10, in a state in which the scratching blade is at a position to scratch the optical fiber, a distance between the first attaching portion side surface and the scratching blade in a normal direction of the first attaching portion side surface may be substantially equal to a distance between the second attaching portion side surface and the scratching blade in a normal direction of the second attaching portion side surface.

According to aspect 11 of one or more embodiments, in either case in which the pedestal part is attached to the first attaching portion or the second attaching portion, it is possible to appropriately perform positioning between the placement surface and the scratching blade in the first direction.

Also, according to aspect 12 of one or more embodiments, in the optical fiber cutting device of aspect 10 or 11, the pedestal part may include a second pressing part pressing the second positioning surface against the first attaching portion side surface or the second attaching portion side surface when the pedestal part is attached to the first attaching portion or the second attaching portion.

According to aspect 12 of one or more embodiments, it is possible to further improve a positioning accuracy of the placement surface in the first direction.

Also, in the optical fiber cutting device of any one of aspects 1 to 12, aspect 13 of one or more embodiments may further include a waste bin part having an accommodating space which is capable of accommodating fiber scraps generated from the optical fiber and being attachable to either the first attaching portion or the second attaching portion.

According to aspect 13 of one or more embodiments, it is possible to further improve usability of the optical fiber cutting device.

Also, according to aspect 14 of one or more embodiments, in the optical fiber cutting device of aspect 13, the waste bin part may include a third pressing part pressing the waste bin part against the first attaching portion or the second attaching portion when the waste bin part is attached to the first attaching portion or the second attaching portion.

According to aspect 14 of one or more embodiments, it is possible to easily perform positioning of the waste bin.

According to the above-described aspects of one or more embodiments, it is possible to provide an optical fiber cutting device with improved usability.

### BRIEF DESCRIPTION OF THE DRAWINGS

FIG. 1 is a perspective view of an optical fiber cutting device according to one or more embodiments in a first attaching state.

FIG. 2 is an exploded view illustrating the optical fiber cutting device of FIG. 1.

FIG. 3 is a perspective view of the optical fiber cutting device according to one or more embodiments in a second attaching state.

FIG. 4 is an exploded view illustrating the optical fiber cutting device of FIG. 3.

FIG. 5 is a view illustrating an attaching portion according to one or more embodiments.

FIG. 6 is a view of the attaching portion in FIG. 5 from an arrow VI.

FIG. 7 is a view illustrating a pedestal part according to one or more embodiments.

FIG. 8 is a view in which the pedestal part of FIG. 7 is vertically turned over.

FIG. 9 is a view of the pedestal part in FIG. 7 from an arrow IX.

FIG. 10 is a view illustrating a waste bin part according to one or more embodiments.

FIG. 11 is a view of the waste bin part in FIG. 10 from an arrow XI.

### DESCRIPTION OF THE EMBODIMENTS

Hereinafter, an optical fiber cutting device according to one or more embodiments will be described on the basis of the drawings.

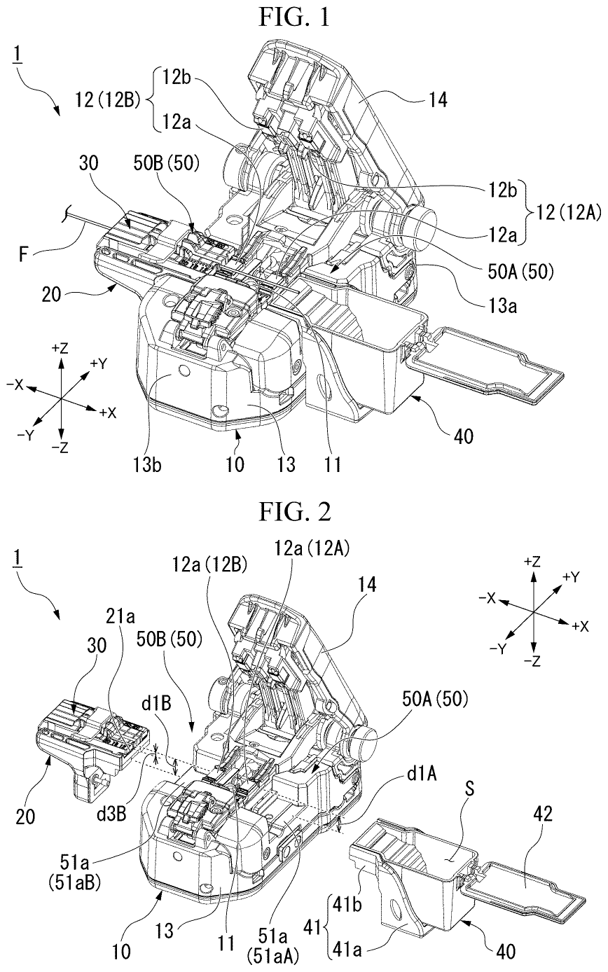

As illustrated in FIG. 1, an optical fiber cutting device 1 according to one or more embodiments includes a main body part 10, a pedestal part 20, and a waste bin part 40. A fiber holder 30 that holds an optical fiber F is able to be placed on the pedestal part 20. The fiber holder 30 may be fixed to the pedestal part 20 with screws, or may be fixed with means other than screws (for example, magnets, or the like). A configuration of the fiber holder 30 is not particularly limited as long as it is able to hold the optical fiber F, and may be changed as appropriate.

The main body part 10 includes a scratching blade 11 that scratches the optical fiber F extending from the pedestal part 20. The scratching blade 11 has a flat plate shape (disc shape in the illustrated example). The scratching blade 11 according to one or more embodiments scratches the optical fiber F by sliding in a direction parallel to the scratching blade 11. The scratching blade 11 may be configured to be movable between a position at which the optical fiber F is scratched (scratching position) and a position at which the optical fiber F is not scratched (non-scratching position). Note that, in the following description, unless otherwise specified, a positional relationship of parts with the scratching blade 11 at the scratching position will be described. The main body part 10 according to one or more embodiments includes a base part 13 in which the scratching blade 11 is provided and an opening/closing part 14 connected to the base part 13 to be openable and closable. The base part 13 includes a connection end portion 13a to which the opening/closing part 14 is connected, and a free end portion 13b positioned on a side opposite to the connection end portion 13a.

As illustrated in FIGS. 1 to 4, the main body part 10 includes a first attaching portion 50A and a second attaching portion 50B. In a longitudinal direction of the optical fiber F (a longitudinal direction X to be described later), the first attaching portion 50A and the second attaching portion 50B are positioned on opposite sides from each other when viewed from the scratching blade 11. In other words, it is also possible to understand that, in a state in which the scratching blade 11 is at a position to scratch the optical fiber F, the first attaching portion 50A and the second attaching portion 50B are positioned on opposite sides from each other with respect to the scratching blade 11. In a state in which the scratching blade 11 is at a position to scratch the optical fiber F, the first attaching portion 50A, the scratching blade 11, and the second attaching portion 50B are arranged in one direction (the longitudinal direction X to be described later).

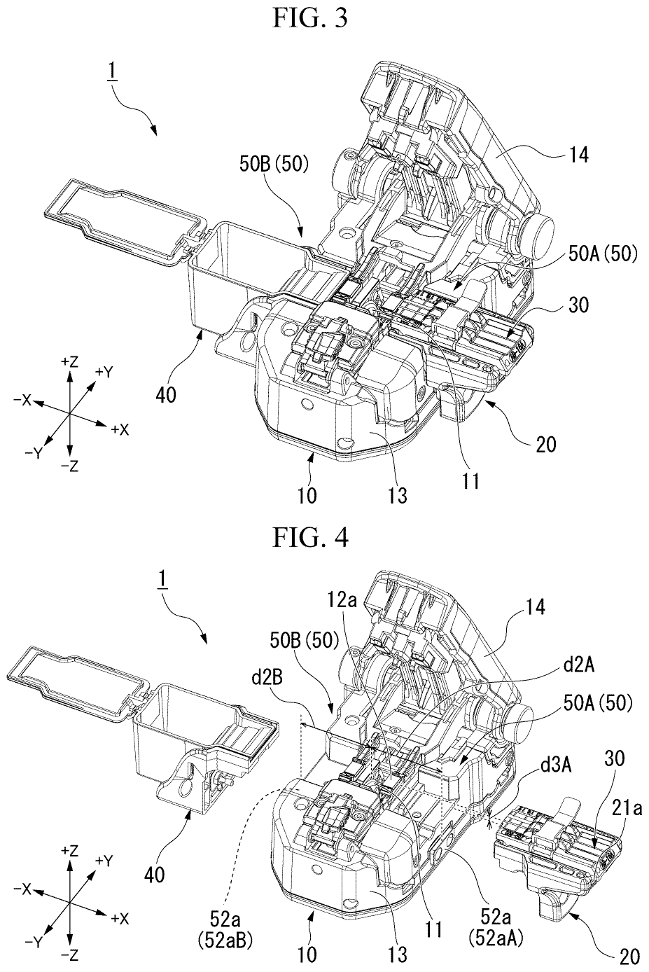

Either the pedestal part 20 or the waste bin part 40 is attached to each of the attaching portions 50A and 50B. That is, the optical fiber cutting device 1 according to one or more embodiments may take two states: a first attaching state (FIGS. 1 and 2) and a second attaching state (FIGS. 3 and 4). The first attaching state (FIGS. 1 and 2) is a state in which the waste bin part 40 is attached to the first attaching portion 50A, and the pedestal part 20 is attached to the second attaching portion 50B. The second attaching state (FIGS. 3 and 4) is a state in which the pedestal part 20 is attached to the first attaching portion 50A, and the waste bin part 40 is attached to the second attaching portion 50B. However, the optical fiber cutting device 1 may not need to include the waste bin part 40. In the following description, unless otherwise specified, a positional relationship of parts when the optical fiber cutting device 1 is in the first attaching state (FIGS. 1 and 2) will be described.

### (Definition of Directions)

In the present specification, a longitudinal direction of the optical fiber F is simply referred to as the longitudinal direction X. The longitudinal direction X is also a direction that intersects (for example, is orthogonal to) a direction in which the scratching blade 11 slides. The longitudinal direction X is also a direction in which the first attaching portion 50A and the second attaching portion 50B are arranged. The longitudinal direction X is also a direction in which the first attaching portion 50A, the scratching blade 11, and the second attaching portion 50B are arranged in a state in which the scratching blade 11 is at a position to scratch the optical fiber F. A direction from the second attaching portion 50B to the first attaching portion 50A in the longitudinal direction X is referred to as a +X direction or a rightward direction. A direction opposite to the +X direction is referred to as a −X direction or a leftward direction. In the longitudinal direction X, a side toward the scratching blade 11 is referred to as an inward side, and a side away from the scratching blade 11 is referred to as an outward side. Also, in a state in which the opening/closing part 14 is closed, a direction in which the base part 13 and the opening/closing part 14 are arranged is referred to as a vertical direction Z. The vertical direction Z is also a direction that intersects (for example, is orthogonal to) a clamping surface 12a and a placement surface 21a to be described later. The vertical direction Z intersects (for example, is orthogonal to) the longitudinal direction X. A direction from the base part 13 toward the opening/closing part 14 in the vertical direction Z is referred to as a +Z direction or an upward direction. A direction opposite to the +Z direction is referred to as a −Z direction or a downward direction. Also, a direction in which the connection end portion 13a and the free end portion 13b are arranged is referred to as a cross direction Y. The cross direction Y intersects (for example, is orthogonal to) both the longitudinal direction X and the vertical direction Z. A direction from the free end portion 13b toward the connection end portion 13a in the cross direction Y is referred to as a +Y direction or a rearward direction. A direction opposite to the +Y direction is referred to as a −Y direction or a forward direction. The cross direction Y may be a direction in which the scratching blade 11 slides. The longitudinal direction X and the cross direction Y are also directions parallel to the clamping surface 12a and the placement surface 21a to be described later. In one or more embodiments, the longitudinal direction X and the vertical direction Z are also directions (attaching directions) in which the pedestal part 20 is attached to the first attaching portion 50A or the second attaching portion 50B. It is also possible to define the longitudinal direction X as “a direction parallel to the placement surface 21a among the directions (attaching directions) in which the pedestal part 20 is attached to the first attaching portion 50A or the second attaching portion 50B”. The longitudinal direction X is also referred to as a first direction. It is also possible to define the vertical direction Z as “a direction intersecting (for example, being orthogonal to) the placement surface 21a among the directions (attaching directions) in which the pedestal part 20 is attached to the first attaching portion 50A or the second attaching portion 50B”. The vertical direction Z is also referred to as a second direction. It is also possible to define the cross direction Y as “a direction intersecting (for example, being orthogonal to) the directions (attaching directions) in which the pedestal part 20 is attached to the first attaching portion 50A or the second attaching portion 50B”.

As illustrated in FIG. 1, the main body part 10 includes two clamps 12 that clamp the optical fiber F extending from the pedestal part 20. The two clamps 12 are disposed to sandwich the scratching blade 11 therebetween in the longitudinal direction X. Hereinafter, the clamp 12 on a right side (on the first attaching portion 50A side) of the scratching blade 11 is referred to as a first clamp 12A, and the clamp 12 on a left side (on the second attaching portion 50B side) of the scratching blade 11 is referred to as a second clamp 12B.

Each of the clamps 12A and 12B has the clamping surface 12a provided on the base part 13 and a pressing surface 12b provided on the opening/closing part 14. Each of the clamp 12A and 12B clamps the optical fiber F with the clamping surface 12a and the pressing surface 12b. When the opening/closing part 14 is closed, the pressing surface 12b presses the optical fiber F against the clamping surface 12a. The clamping surface 12a faces upward. The clamping surface 12a supports the optical fiber F that is clamped (pressed by the pressing surface 12b). The clamp 12 (the clamping surface 12a and the pressing surface 12b) may be formed of an elastic member such as rubber.

As illustrated in FIGS. 1 to 4, the two attaching portions 50A and 50B are positioned on both side portions of the main body part 10 in the longitudinal direction X. That is, the first attaching portion 50A is positioned at a right portion of the main body part 10, and the second attaching portion 50B is positioned at a left portion of the main body part 10. Here, when viewed from the outside in the longitudinal direction X, a shape of the first attaching portion 50A and a shape of the second attaching portion 50B are substantially the same. Therefore, in the following, unless otherwise specified, of the two attaching portions 50A and 50B, the second attaching portion 50B will represent them and be referred to as the “attaching portion 50,” and only a shape of the second attaching portion 50B will be described in detail.

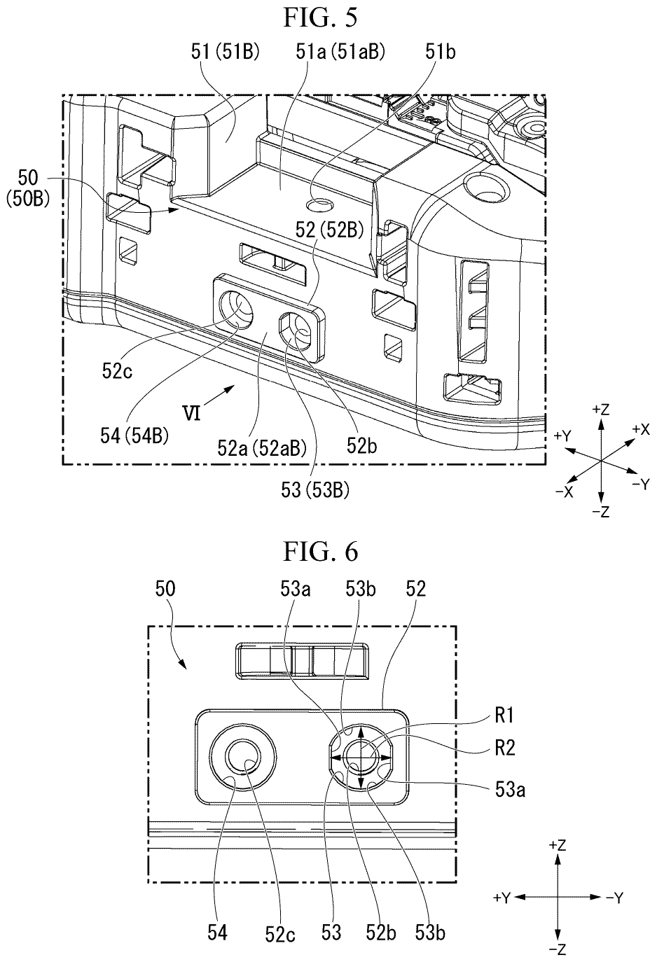

As illustrated in FIG. 5, the attaching portion 50 according to one or more embodiments includes a disposition recessed portion 51 and a projecting portion 52. In the present specification, the disposition recessed portion 51 and the projecting portion 52 of the first attaching portion 50A may be referred to as a first disposition recessed portion 51A and a first projecting portion 52A. Also, the disposition recessed portion 51 and the projecting portion 52 of the second attaching portion 50B may be referred to as a second disposition recessed portion 51B and a second projecting portion 52B.

The disposition recessed portion 51 is a recessed portion that opens to both a side surface (a surface facing the outside in the longitudinal direction X) and an upper surface of the main body part 10. The disposition recessed portion 51 has an attaching portion bottom surface 51a facing upward. The attaching portion bottom surface 51a is also referred to as an attaching portion surface 51a. The attaching portion bottom surface 51a in one or more embodiments is parallel to the clamping surface 12a. In the present specification, the attaching portion bottom surface 51a of the first attaching portion 50A may be referred to as a first attaching portion bottom surface 51aA, and the attaching portion bottom surface 51a of the second attaching portion 50B may be referred to as a second attaching portion bottom surface 51aB. A first screw hole 51b opens to the attaching portion bottom surface 51a. The first screw hole 51b extends downward from the attaching portion bottom surface 51a.

The projecting portion 52 protrudes outward in the longitudinal direction X from the side surface of the main body part 10. The projecting portion 52 has an attaching portion side surface 52a facing outward in the longitudinal direction X. In the present specification, the attaching portion side surface 52a of the first attaching portion 50A may be referred to as a first attaching portion side surface 52aA, and the attaching portion side surface 52a of the second attaching portion 50B may be referred to as a second attaching portion side surface 52aB.

As illustrated in FIGS. 5 and 6, a fitting recessed portion 53 and an auxiliary recessed portion 54 are formed in the projecting portion 52. In the present specification, the fitting recessed portion 53 and the auxiliary recessed portion 54 of the first attaching portion 50A may be referred to as a first fitting recessed portion 53A and a first auxiliary recessed portion 54A, and the fitting recessed portion 53 and the auxiliary recessed portion 54 of the second attaching portion 50B may be referred to as a second fitting recessed portion 53B and a second auxiliary recessed portion 54B. A second screw hole 52b opens to a bottom surface (a surface facing outward in the longitudinal direction X) of the fitting recessed portion 53. An auxiliary screw hole 52c opens to a bottom surface (a surface facing outward in the longitudinal direction X) of the auxiliary recessed portion 54. The screw holes 52b and 52c extend inward in the longitudinal direction X from the bottom surfaces of the recessed portions 53 and 54.

The recessed portions 53 and 54 are each recessed inward in the longitudinal direction X from the attaching portion side surface 52a. The fitting recessed portion 53 and the auxiliary recessed portion 54 are arranged in the cross direction Y. As illustrated in FIG. 6, in a cross-sectional view orthogonal to the longitudinal direction X, shapes of the recessed portions 53 and 54 are different from each other. That is, a cross-sectional shape of the auxiliary recessed portion 54 is circular, and a cross-sectional shape of the fitting recessed portion 53 is oval. A major axis of the fitting recessed portion 53 extends in the vertical direction Z, and a minor axis thereof extends in the cross direction Y.

Specifically, an inner circumferential surface of the fitting recessed portion 53 according to one or more embodiments includes a pair of linear portions 53a and a pair of arcuate portions 53b in a cross-sectional view orthogonal to the longitudinal direction X. Each of the linear portions 53a extends linearly in the vertical direction Z. The pair of linear portions 53a face each other in the cross direction Y. The pair of arcuate portions 53b connect both ends (upper ends and lower ends) of the linear portions 53a. The arcuate portions 53b each extend in an arcuate shape. An inner diameter R1 of the fitting recessed portion 53 in the vertical direction Z is larger than an inner diameter R2 of the fitting recessed portion 53 in the cross direction Y.

Here, in one or more embodiments, a distance d1A and a distance d1B illustrated in FIG. 2 are substantially equal. The distance d1A is a distance between the first attaching portion bottom surface 51aA and the clamping surface 12a (the clamping surface 12a of the first clamp 12A) in a normal direction of the first attaching portion bottom surface 51aA (that is, the vertical direction Z). The distance d1B is a distance between the second attaching portion bottom surface 51aB and the clamping surface 12a (the clamping surface 12a of the second clamp 12B) in a normal direction of the second attaching portion bottom surface 51aB (that is, the vertical direction Z). However, the phrase “substantially equal” also includes a case in which it may be regarded as being equal if manufacturing errors are removed. The same applies to the following description.

Also, in one or more embodiments, a distance d2A and a distance d2B illustrated in FIG. 4 are substantially equal. The distance d2A is a distance between the first attaching portion side surface 52aA and the scratching blade 11 in a normal direction of the first attaching portion side surface 52aA (that is, the longitudinal direction X). The distance d2B is a distance between the second attaching portion side surface 52aB and the scratching blade 11 in a normal direction of the second attaching portion side surface 52aB (that is, the longitudinal direction X).

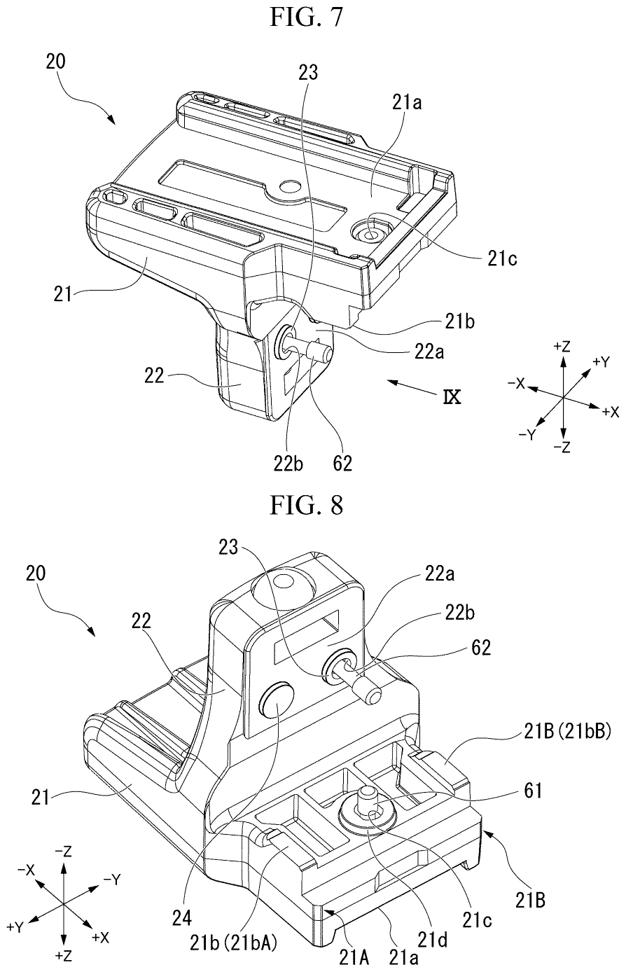

As illustrated in FIGS. 7 and 8, the pedestal part 20 according to one or more embodiments includes a placement portion 21, an extension portion 22, a first pressing means 61 (not illustrated in FIG. 7), and a second pressing means 62. The pressing means 61 and 62 according to one or more embodiments are screws. The first pressing means 61 is also referred to as a first pressing part 61. The second pressing means 62 is also referred to as a second pressing part 62.

The placement portion 21 according to one or more embodiments has a substantially plate-like shape extending in the longitudinal direction X and the cross direction Y. The placement portion 21 (pedestal part 20) has a first side edge portion 21A and a second side edge portion 21B (see FIG. 8). The first side edge portion 21A is positioned on one side in the cross direction Y (+Y side in the illustrated example). The second side edge portion 21B is positioned on the other side in the cross direction Y (the −Y side in the illustrated example). That is, the second side edge portion 21B is positioned on a side opposite to the first side edge portion 21A in the cross direction Y. The placement portion 21 has the placement surface 21a and a first positioning surface 21b. Also, a first through hole 21c is formed in the placement portion 21.

The fiber holder 30 (see also FIGS. 1 to 4) is placed on the placement surface 21a. The placement surface 21a intersects (for example, is orthogonal to) the vertical direction Z. That is, the placement surface 21a faces upward.

The first positioning surface 21b is provided on a side opposite to the placement surface 21a in the placement portion 21. That is, the first positioning surface 21b faces downward. In one or more embodiments, the placement surface 21a and the first positioning surface 21b are parallel to each other. As illustrated in FIG. 8, the first positioning surface 21b is positioned on the inward side of the extension portion 22 in the longitudinal direction X. When the pedestal part 20 is attached to the attaching portion 50 (the first attaching portion 50A or the second attaching portion 50B), the first positioning surface 21b is in contact with the attaching portion bottom surface 51a (the first attaching portion bottom surface 51aA or the second attaching portion bottom surface 51aB) of the attaching portion 50.

The first positioning surface 21b according to one or more embodiments is divided into two surfaces. In other words, the placement portion 21 according to one or more embodiments has two first positioning surfaces 21b. The two first positioning surfaces 21b are disposed at a distance from each other in the cross direction Y. One first positioning surface 21bA is provided on the first side edge portion 21A. The other first positioning surface 21bB is provided on the second side edge portion 21B. Each of the divided first positioning surfaces 21b has an area smaller than an area of the attaching portion bottom surface 51a.

As illustrated in FIG. 7, the first through hole 21c opens to the placement surface 21a. The first through hole 21c extends downward from the placement surface 21a and penetrates the placement portion 21 in the vertical direction Z. As illustrated in FIG. 8, the first through hole 21c is positioned between the two first positioning surfaces 21b in the cross direction Y. Also, as illustrated in FIG. 8, an annular protrusion portion 21d protruding downward may be provided at a lower end of the first through hole 21c.

As illustrated in FIG. 7, the extension portion 22 extends downward from a center portion of the placement portion 21 in the longitudinal direction X. The extension portion 22 has a substantially plate-like shape extending in the vertical direction Z and the cross direction Y. The extension portion 22 has a second positioning surface 22a. Also, a second through hole 22b is formed in the extension portion 22. The second through hole 22b opens to the second positioning surface 22a (a protruding portion 23 to be described later) and penetrates the extension portion 22 in the longitudinal direction X.

The second positioning surface 22a intersects (for example, is orthogonal to) the longitudinal direction X. That is, the second positioning surface 22a according to one or more embodiments faces inward in the longitudinal direction X. When the pedestal part 20 is attached to the attaching portion 50 (the first attaching portion 50A or the second attaching portion 50B), the second positioning surface 22a is in contact with the attaching portion side surface 52a (the first attaching portion side surface 52aA or the second attaching portion side surface 52aB) of the attaching portion 50.

As illustrated in FIGS. 7 and 8, the protruding portion 23 and an auxiliary protruding portion 24 are formed on the extension portion 22. The protruding portion 23 and the auxiliary protruding portion 24 each protrude inward in the longitudinal direction X from the second positioning surface 22a. The above-described second through hole 22b opens in the protruding portion 23. Thereby, the protruding portion 23 has an annular shape when viewed from the longitudinal direction X.

The protruding portion 23 and the auxiliary protruding portion 24 are arranged in the cross direction Y. A distance between the protruding portion 23 and the auxiliary protruding portion 24 is substantially equal to a distance between the fitting recessed portion 53 and the auxiliary recessed portion 54 of the attaching portion 50. When the pedestal part 20 is attached to the attaching portion 50 (the first attaching portion 50A or the second attaching portion 50B), the protruding portion 23 is fitted into the fitting recessed portion 53 (the first fitting recessed portion 53A or the second fitting recessed portion 53B), and the auxiliary protruding portion 24 is fitted into the auxiliary recessed portion 54 (the first auxiliary recessed portion 54A or the second auxiliary recessed portion 54B).

As illustrated in FIG. 8, in a cross-sectional view orthogonal to the longitudinal direction X, a cross-sectional shape of the protruding portion 23 is circular. More specifically, an outer circumference of the protruding portion 23 has a circular cross-sectional shape. In the illustrated example, a cross-sectional shape of the auxiliary protruding portion 24 is also circular. An outer diameter r of the protruding portion 23 is substantially equal to an inner diameter R2 of the auxiliary recessed portion 54 in the cross direction Y.

As illustrated in FIGS. 2 and 10, the waste bin part 40 according to one or more embodiments includes an accommodating part 41, a lid part 42, and two third pressing means 63. The third pressing means 63 according to one or more embodiments is a screw. Note that, the number of the third pressing means 63 may be changed as appropriate. The third pressing means 63 is also referred to as a third pressing part 63.

As illustrated in FIG. 2, an accommodating space S is formed in the accommodating part 41. The accommodating space S is a space capable of accommodating fiber scraps generated from the optical fiber F when the optical fiber cutting device 1 is in use or the like. In the illustrated example, the accommodating space S opens at an upper end of the accommodating part 41. The accommodating part 41 may be formed by one member, or may be formed by combining two or more members. The accommodating part 41 according to one or more embodiments includes a main portion 41a and a claw portion 41b extending inward in the longitudinal direction X from an upper end portion of the main portion 41a.

The lid part 42 is connected to the accommodating part 41 (the claw portion 41b in the illustrated example) to be able to switch between a closed state in which an opening end of the accommodating part 41 is closed and an open state in which the opening end is not closed. However, the waste bin part 40 may not need to have the lid part 42.

As illustrated in FIG. 10, the accommodating part 41 (main portion 41a) has a third positioning surface 41c. Also, a first positioning protrusion portion 43, a second positioning protrusion portion 44, and two insertion holes 41d are formed in the accommodating part 41 (main portion 41a).

The third positioning surface 41c intersects (for example, is orthogonal to) the longitudinal direction X. That is, the third positioning surface 41c according to one or more embodiments faces inward in the longitudinal direction X. When the waste bin part 40 is attached to the attaching portion 50 (the first attaching portion 50A or the second attaching portion 50B), the third positioning surface 41c is in contact with the attaching portion side surface 52a (the first attaching portion side surface 52aA or the second attaching portion side surface 52aB) of the attaching portion 50.

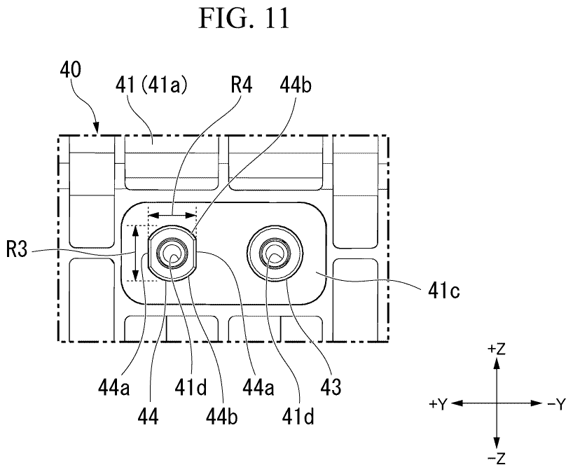

Each of the first positioning protrusion portion 43 and the second positioning protrusion portion 44 protrudes inward in the longitudinal direction X from the third positioning surface 41c. One insertion hole 41d described above opens at each of the first positioning protrusion portion 43 and the second positioning protrusion portion 44. Thereby, as illustrated in FIG. 11, each of the first positioning protrusion portion 43 and the second positioning protrusion portion 44 has an annular shape when viewed from the longitudinal direction X.

The first positioning protrusion portion 43 and the second positioning protrusion portion 44 are arranged in the cross direction Y. A distance between the first positioning protrusion portion 43 and the second positioning protrusion portion 44 is substantially equal to the distance between the fitting recessed portion 53 and the auxiliary recessed portion 54 of the attaching portion 50. When the waste bin part 40 is attached to the attaching portion 50 (the first attaching portion 50A or the second attaching portion 50B), the first positioning protrusion portion 43 is fitted into the auxiliary recessed portion 54 (the first auxiliary recessed portion 54A or the second auxiliary recessed portion 54B), and the second positioning protrusion portion 44 is fitted into the fitting recessed portion 53 (the first fitting recessed portion 53A or the second fitting recessed portion 53B).

As illustrated in FIG. 11, in a cross-sectional view orthogonal to the longitudinal direction X, shapes of the positioning protrusion portions 43 and 44 are different from each other. That is, a cross-sectional shape of the first positioning protrusion portion 43 is circular, and a cross-sectional shape of the second positioning protrusion portion 44 is oval. A major axis of the second positioning protrusion portion 44 extends in the vertical direction Z, and a minor axis thereof extends in the cross direction Y.

Specifically, an outer circumferential surface of the second positioning protrusion portion 44 according to one or more embodiments includes a pair of linear portions 44a and a pair of arcuate portions 44b in a cross-sectional view orthogonal to the longitudinal direction X. The linear portions 44a each extend linearly in the vertical direction Z. The pair of linear portions 44a are arranged in the cross direction Y. The pair of arcuate portions 44b connect both ends (upper ends and lower ends) of the linear portions 44a. The arcuate portions 44b each extend in an arcuate shape. An outer diameter R3 of the second positioning protrusion portion 44 in the vertical direction Z is larger than an outer diameter R4 of the second positioning protrusion portion 44 in the cross direction Y. The outer diameter R3 of the second positioning protrusion portion 44 in the vertical direction Z is substantially equal to the inner diameter R1 (see FIG. 6) of the fitting recessed portion 53 in the vertical direction Z. The outer diameter R4 of the second positioning protrusion portion 44 in the cross direction Y is smaller than the inner diameter R2 (see FIG. 6) of the fitting recessed portion 53 in the cross direction Y.

Next, an operation of the optical fiber cutting device 1 configured as above will be described.

In a conventional optical fiber cutting device (see, for example, Patent Document 1), a fiber holder holding an optical fiber is fixed on one side (for example, a right side) when viewed from a scratching blade that scratches the optical fiber. Therefore, there have been cases in which an operation thereof is difficult to perform depending on a user's dominant hand, resulting in poor usability of the optical fiber cutting device.

Also, when working with the optical fiber cutting device placed on a workbench or the like, the user generally performs the work with a front side (the free end portion 13b in FIG. 1) of the optical fiber cutting device facing the user himself/herself. However, depending on a work environment such as an overhead or narrow space, a work table or the like on which the optical fiber cutting device is placed may not be usable. In this case, the user may work with a back side (the connection end portion 13a part in FIG. 1) of the optical fiber cutting device facing the user himself/herself. That is, the user may work with the optical fiber cutting device reversed in direction (front and back). In the conventional configuration in which the fiber holder is fixed to one side of the scratching blade, it may be difficult to perform the work with the front and back of the optical fiber cutting device reversed as described above.

On the other hand, the optical fiber cutting device 1 according to one or more embodiments includes two attaching portions 50A and 50B to which the fiber holder 30 is able to be attached. Then, the two attaching portions 50A and 50B are provided on opposite sides from each other when viewed from the scratching blade 11. Thereby, it is possible for the user, according to his/her will, to attach the pedestal part 20 that holds the fiber holder 30 to either the first attaching portion 50A on one side when viewed from the scratching blade 11 or the second attaching portion 50B on the other side when viewed from the scratching blade 11. Therefore, it is possible to improve usability of the optical fiber cutting device 1 regardless of a user's dominant hand or a direction (front and back) of the optical fiber cutting device 1.

Also, from a viewpoint of ensuring a cutting performance of the optical fiber cutting device 1, a positional relationship between the clamping surface 12a and the optical fiber F is important. Specifically, it is important that a relative position between the optical fiber F and the clamping surface 12a in the vertical direction Z is appropriate, and the optical fiber F is parallel to the clamping surface 12a. Here, the optical fiber F is held by the fiber holder 30. Therefore, in order to make the positional relationship (a relative position in the vertical direction Z and a relative angle) between the clamping surface 12a and the optical fiber F appropriate, it is important to make a positional relationship (a relative position in the vertical direction Z and a relative angle) between the optical fiber F and the placement surface 21a on which the fiber holder 30 is placed appropriate.

Also, if a length of the optical fiber F to be cut (a position of a cutting point in the longitudinal direction X) varies, this may affect fusion splicing work or the like that is performed after the cutting work. Further, if a position of the optical fiber F varies in the cross direction Y, the optical fiber F may not be placed on the clamping surface 12a, making it difficult to cut the optical fiber F. Therefore, it is also important to appropriately position the optical fiber F (the placement surface 21a) in the longitudinal direction X and the cross direction Y.

In this regard, the optical fiber cutting device 1 according to one or more embodiments is configured such that the placement surface 21a is appropriately positioned when the pedestal part 20 is attached to the attaching portions 50A or 50B. Hereinafter, positioning of the placement surface 21a will be described in detail.

When the pedestal part 20 is attached to the attaching portion 50 (the first attaching portion 50A or the second attaching portion 50B), the user brings the first positioning surface 21b into contact with the attaching portion bottom surface 51a, brings the second positioning surface 22a into contact with the attaching portion side surface 52a, and fits the protruding portion 23 into the fitting recessed portion 53 (see, for example, FIGS. 5 and 7).

Here, when the first positioning surface 21b and the attaching portion bottom surface 51a are in contact (surface contact) with each other, positioning between the placement surface 21a and the clamping surface 12a are achieved in the vertical direction Z. At this time, the placement surface 21a and the clamping surface 12a become parallel (substantially parallel). This is because, for example, the placement surface 21a and the first positioning surface 21b are parallel, the attaching portion bottom surface 51a and the clamping surface 12a are parallel, and the first positioning surface 21b and the attaching portion bottom surface 51a are parallel. Also, as described above, in one or more embodiments, the distance d1A between the first attaching portion bottom surface 51aA and the clamping surface 12a and the distance d1B between the second attaching portion bottom surface 51aB and the clamping surface 12a are substantially equal (see FIG. 2). Therefore, in either case in which the pedestal part 20 is attached to the first attaching portion 50A or the second attaching portion 50B, it is possible to appropriately perform positioning between the placement surface 21a and the clamping surface 12a in the vertical direction Z. That is, a distance d3A illustrated in FIG. 4 and a distance d3B illustrated in FIG. 2 are substantially equal. The distance d3A is a distance between the placement surface 21a and the clamping surface 12a when the pedestal part 20 is attached to the first attaching portion 50A. The distance d3B is a distance between the placement surface 21a and the clamping surface 12a when the pedestal part 20 is attached to the second attaching portion 50B. Note that, both the distance d3A and the distance d3B are distances in a normal direction of the clamping surface 12a (that is, the vertical direction Z). When the placement surface 21a and the clamping surface 12a are substantially parallel, and the distance d3A and the distance d3B are substantially equal, in either case in which the pedestal part 20 is attached to the first attaching portion 50A or the second attaching portion 50B, it is possible to cut the optical fiber F in the same way. The difference between the distance d3A and the distance d3B may be 0.5 mm or less. The distance d3A and the distance d3B may be equal.

Note that, when the first positioning surface 21b and the attaching portion bottom surface 51a are in contact with each other, the placement surface 21a and the clamping surface 12a may not have to be completely parallel. That is, the phrase “the placement surface 21a and the clamping surface 12a are parallel (substantially parallel)” according to one or more embodiments includes a case in which the placement surface 21a and the clamping surface 12a are not completely parallel. Even if the placement surface 21a is slightly inclined with respect to the clamping surface 12a, it may not be a practical matter as a function of the optical fiber cutting device 1 that cuts the optical fiber F. For example, as long as a magnitude of an inclined angle of the placement surface 21a with respect to the clamping surface 12a is 1.0° or less, there is no practical matter in the function of the optical fiber cutting device 1. That is, the phrase “the placement surface 21a and the clamping surface 12a are parallel (substantially parallel)” according to one or more embodiments also includes a case in which the placement surface 21a is inclined with respect to the clamping surface 12a to such an extent that there is no practical matter in the function of the optical fiber cutting device 1 (for example, a magnitude of the inclined angle of the placement surface 21a with respect to the clamping surface 12a is 1.0° or less).

Also, when the second positioning surface 22a and the attaching portion side surface 52a are in contact (surface contact) with each other, positioning between the placement surface 21a and the scratching blade 11 are achieved in the longitudinal direction X. Also, as described above, in one or more embodiments, the distance d2A between the first attaching portion side surface 52aA and the scratching blade 11 is substantially equal to the distance d2B between the second attaching portion side surface 52aB and the scratching blade 11 (see FIG. 4). Therefore, in either case in which the pedestal part 20 is attached to the first attaching portion 50A or the second attaching portion 50B, it is possible to appropriately perform the positioning between the placement surface 21a and the scratching blade 11 in the longitudinal direction X. The difference between the distance d2A and the distance d2B may be 0.5 mm or less. The distance d2A and the distance d2B may be equal.

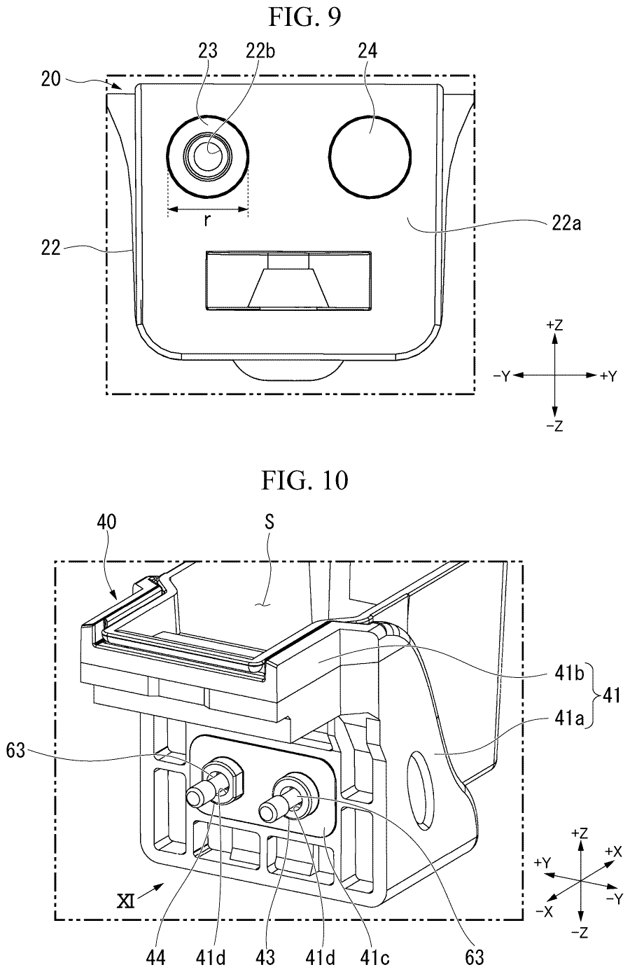

Also, when the protruding portion 23 is fitted into the fitting recessed portion 53, positioning between the placement surface 21a and the clamping surface 12a are achieved in the cross direction Y. Here, as described above, in one or more embodiments, a cross-sectional shape of the fitting recessed portion 53 is an oval shape extending in the vertical direction Z, and a cross-sectional shape of the protruding portion 23 is a circular shape (see FIGS. 6 and 9). Therefore, the protruding portion 23 makes contact with the linear portions 53a of the inner circumferential surface of the fitting recessed portion 53 and has difficulty in making contact with the arcuate portions 53b. That is, the protruding portion 23 and the fitting recessed portion 53 have difficulty in making contact with each other in the vertical direction Z while making contact with each other in the cross direction Y. If the protruding portion 23 and the fitting recessed portion 53 make contact with each other in the vertical direction Z, there is a likelihood that the positioning in the vertical direction Z performed by the first positioning surface 21b and the attaching portion bottom surface 51a will be hindered. When a cross-sectional shape of the fitting recessed portion 53 is made to be oval and a cross-sectional shape of the protruding portion 23 is made to be circular, it is possible to prevent such hindrance in positioning. Therefore, it is possible to improve a positioning accuracy in the vertical direction Z more reliably.

After the first positioning surface 21b is brought into contact with the attaching portion bottom surface 51a, the user screws the first pressing means 61 into the first screw hole 51b of the attaching portion 50 while inserting the first pressing means 61 into the first through hole 21c of the pedestal part 20 (see, for example, FIGS. 5 and 8). Thereby, the first pressing means 61 (a head portion of the screw) presses the first positioning surface 21b toward the attaching portion bottom surface 51a. Therefore, it is possible to perform a surface contact between the first positioning surface 21b and the attaching portion bottom surface 51a more reliably, and it is possible to further improve the positioning accuracy in the vertical direction Z. Note that, a height (a dimension in the vertical direction Z) of the annular protrusion portion 21d (see FIG. 8) may be adjusted as appropriate so that the annular protrusion portion 21d does not hinder the surface contact between the first positioning surface 21b and the attaching portion bottom surface 51a, and the annular protrusion portion 21d is able to prevent the pedestal part 20 (the placement portion 21) from bending due to a pressing force of the first pressing means 61.

Further, in one or more embodiments, the first positioning surface 21b is divided into a plurality of surfaces. The first positioning surface 21b may be curved in a protruding shape due to manufacturing or the like. If the first positioning surface 21b is constituted by only one surface and has an area similar to that of the attaching portion bottom surface 51a, there is a likelihood that a center portion of the first positioning surface 21b will have a convex shape. In this case, the positioning accuracy in the vertical direction Z may decrease. When the first positioning surface 21b is divided into a plurality of surfaces and an area of each surface is reduced as in one or more embodiments, it is possible to suppress such a decrease in positioning accuracy.

After the second positioning surface 22a is brought into contact with the attaching portion side surface 52a, and the protruding portion 23 is fitted into the fitting recessed portion 53, the user screws the second pressing means 62 into the second screw hole 52b of the attaching portion 50 while inserting the second pressing means 62 into the second through hole 22b of the pedestal part 20 (see, for example, FIGS. 5 and 8). Thereby, the second pressing means 62 (a head portion of the screw) presses the second positioning surface 22a toward the attaching portion side surface 52a. Therefore, it is possible to perform a surface contact between the second positioning surface 22a and the attaching portion side surface 52a more reliably, and it is possible to further improve the positioning accuracy in the longitudinal direction X.

Also, the optical fiber cutting device 1 according to one or more embodiments includes the waste bin part 40. Compared to the pedestal part 20, a positioning accuracy of the waste bin part 40 is less important. However, if a position of the waste bin part 40 deviates significantly, the waste bin part 40 may interfere with other parts. Therefore, the optical fiber cutting device 1 according to one or more embodiments is configured such that the waste bin part 40 is appropriately positioned to some extent when the waste bin part 40 is attached to the attaching portion 50A or 50B. Hereinafter, positioning of the waste bin part 40 will be described.

When the waste bin part 40 is attached to the attaching portion 50 (the first attaching portion 50A or the second attaching portion 50B), the user disposes the claw portion 41b in the disposition recessed portion 51, brings the third positioning surface 41c into contact with the attaching portion side surface 52a, fits the first positioning protrusion portion 43 into the auxiliary recessed portion 54, and then fits the second positioning protrusion portion 44 into the fitting recessed portion 53 (see, for example, FIGS. 5 and 10).

When the third positioning surface 41c and the attaching portion side surface 52a are in contact (surface contact) with each other, positioning between the waste bin part 40 and the attaching portion 50 are achieved in the longitudinal direction X.

When the first positioning protrusion portion 43 is fitted into the auxiliary recessed portion 54, positioning between the waste bin part 40 and the attaching portion 50 are achieved in the cross direction Y. Also, when the second positioning protrusion portion 44 is fitted into the fitting recessed portion 53, relative rotation of the waste bin part 40 with respect to the attaching portion 50 around the first positioning protrusion portion 43 and the auxiliary recessed portion 54 is suppressed. More specifically, when the arcuate portions 44b of the second positioning protrusion portion 44 and the arcuate portions 53b of the fitting recessed portion 53 are in contact with each other, the relative rotation of the waste bin part 40 is suppressed. Here, as described above, the outer diameter R4 of the second positioning protrusion portion 44 in the cross direction Y is smaller than the inner diameter R2 of the fitting recessed portion 53 in the cross direction Y (see FIGS. 6 and 11). Therefore, even if a distance between the positioning protrusion portions 43 and 44 and a distance between the recessed portions 53 and 54 are deviated from each other, it is possible to fit the positioning protrusion portions 43 and 44 into the recessed portions 53 and 54.

After the third positioning surface 41c is brought into contact with the attaching portion side surface 52a, the user inserts one of the two third pressing means 63 into each of the two insertion holes 41d of the waste bin part 40. Then, the user screws one of the third pressing means 63 into the second screw hole 52b of the attaching portion 50, and screws the other of the third pressing means 63 into the auxiliary screw hole 52c (see, for example, FIGS. 5 and 10). Thereby, the third pressing means 63 presses the third positioning surface 41c toward the attaching portion side surface 52a. Therefore, it is possible to perform a surface contact between the third positioning surface 41c and the attaching portion side surface 52a more reliably, and it is possible to improve the positioning accuracy in the longitudinal direction X.

Note that, a direction in which the third pressing means 63 is screwed is not limited to the longitudinal direction X, and may be changed as appropriate. However, if a configuration in which the third pressing means 63 is screwed in from above is employed, there is a likelihood that the third pressing means 63 will become a hindrance when fiber scraps are accommodated in the accommodating space S. Therefore, it is preferable that the third pressing means 63 be screwed in from a direction (for example, the longitudinal direction X) other than from above.

As described above, the optical fiber cutting device 1 according to one or more embodiments includes the pedestal part 20 on which the fiber holder 30 holding the optical fiber F is placeable, and a main body part 10 including the scratching blade 11 scratching the optical fiber F, in which, the main body part 10 includes the first attaching portion 50A and the second attaching portion 50B to which the pedestal part 20 is attachable, and, in a state in which the scratching blade 11 is at a position to scratch the optical fiber F, the first attaching portion 50A and the second attaching portion 50B are positioned on opposite sides from each other with respect to the scratching blade 11, and the first attaching portion 50A, the scratching blade 11, and the second attaching portion 50B are arranged in one direction (the longitudinal direction X).

With this configuration, it is possible to improve the usability of the optical fiber cutting device 1 regardless of a user's dominant hand or a direction (front and back) of the optical fiber cutting device 1.

Also, the pedestal part 20 has the placement surface 21a on which the fiber holder 30 is placed, the main body part 10 includes the clamp 12 clamping the optical fiber F, the clamp 12 has the clamping surface 12a supporting the clamped optical fiber F, the placement surface 21a when the pedestal part 20 is attached to the first attaching portion 50A and the placement surface 21a when the pedestal part 20 which has been attached to the first attaching portion 50A is attached to the second attaching portion 50B are substantially parallel to the clamping surface 12a, and the distance d3A between the placement surface 21a and the clamping surface 12a when the pedestal part 20 is attached to the first attaching portion 50A is substantially equal to the distance d3B between the placement surface 21a and the clamping surface 12a when the pedestal part 20 which has been attached to the first attaching portion 50A is attached to the second attaching portion 50B. With this configuration, it is possible to easily perform positioning between the placement surface 21a and the clamping surface 12a in the vertical direction Z. Also, it is possible to make the placement surface 21a and the clamping surface 12a parallel easily. Also, in either case in which the pedestal part 20 is attached to the first attaching portion 50A or the second attaching portion 50B, it is possible to appropriately perform positioning between the placement surface 21a and the clamping surface 12a in the vertical direction Z.

Also, the pedestal part 20 has the first positioning surface 21b parallel to the placement surface 21a, the first attaching portion 50A has the first attaching portion bottom surface (first attaching portion surface) 51aA parallel to the first positioning surface 21b, the second attaching portion 50B has the second attaching portion bottom surface (second attaching portion surface) 51aB parallel to the first positioning surface 21b, the first positioning surface 21b and the first attaching portion bottom surface 51aA are in surface contact when the pedestal part 20 is attached to the first attaching portion 50A, and the first positioning surface 21b and the second attaching portion bottom surface 51aB are in surface contact when the pedestal part 20 is attached to the second attaching portion 50B. With this configuration, it is possible to perform positioning between the placement surface 21a and the clamping surface 12a more easily in the vertical direction Z.

Also, the pedestal part 20 includes the first pressing means (first pressing part) 61 pressing the first positioning surface 21b against the first attaching portion bottom surface 51aA or the second attaching portion bottom surface 51aB when the pedestal part 20 is attached to the first attaching portion 50A or the second attaching portion 50B. With this configuration, it is possible to further improve the positioning accuracy of the placement surface 21a in the vertical direction Z.

Also, the pedestal part 20 has two or more first positioning surfaces 21b. With this configuration, it is possible to further improve the positioning accuracy of the placement surface 21a in the vertical direction Z.

Also, the pedestal part 20 includes the first side edge portion 21A positioned on one side in the cross direction Y intersecting directions (the longitudinal direction X and the vertical direction Z) in which the pedestal part 20 is attached to the first attaching portion 50A or the second attaching portion 50B, and the second side edge portion 21B positioned on a side opposite to the first side edge portion 21A in the cross direction Y, and the pedestal part 20 has the first positioning surface 21bA provided on the first side edge portion 21A, and the first positioning surface 21bB provided on the second side edge portion 21B. When the first positioning surfaces 21bA and 21bB are provided on both the side edge portions 21A and 21B in the cross direction Y, it is possible to attach the pedestal part 20 to the attaching portion 50A or 50B in a well-balanced manner in the vertical direction Z compared to a case in which the first positioning surfaces 21b are provided to be offset to one side (+Y side) or the other side (−Y side) in the cross direction Y. Thereby, it is possible to further improve the positioning accuracy of the placement surface 21a in the vertical direction Z.

Also, the pedestal part 20 includes the protruding portion 23 protruding in the longitudinal direction X (the first direction being a direction parallel to the placement surface 21a among the attaching directions in which the pedestal part 20 is attached to the first attaching portion 50A or the second attaching portion 50B), the first attaching portion 50A has the first fitting recessed portion 53A into which the protruding portion 23 is fitted when the pedestal part 20 is attached, and the second attaching portion 50B has the second fitting recessed portion 53B into which the protruding portion 23 is fitted when the pedestal part 20 is attached. With this configuration, it is possible to easily perform positioning of the placement surface 21a in the cross direction Y and the vertical direction Z.

Also, a cross-sectional shape of the protruding portion 23 perpendicular to the longitudinal direction X is a circular shape, and a cross-sectional shape of the first fitting recessed portion 53A or the second fitting recessed portion 53B perpendicular to the longitudinal direction X is an oval shape with a major axis thereof extending in a direction (the vertical direction Z) intersecting the placement surface 21a. When the protruding portion 23 and the fitting recessed portions 53A and 53B have such shapes, a space is formed between the protruding portion 23 and the fitting recessed portions 53A and 53B due to the oval cross-sectional shapes of the fitting recessed portions 53A and 53B. Therefore, the formation of this space makes it easier for the protruding portion 23 to move more easily in the vertical direction Z through the space. Thereby, the first positioning surface 21b also becomes easier to move in the vertical direction Z, and it is possible to determine the position of the first positioning surface 21b in the vertical direction Z at a predetermined position with high accuracy. Therefore, even if, for example, the first pressing means 61 presses the first positioning surface 21b toward the attaching portion bottom surfaces 51aA and 51aB, it is possible to reduce a likelihood that the positioning between the first positioning surface 21b and the attaching portion bottom surfaces 51aA and 51aB in the vertical direction Z is disrupted, compared to a case in which they do not have the shapes described above. If the protruding portion 23 and the fitting recessed portions 53A and 53B do not have such a shape, the protruding portion 23 and the fitting recessed portions 53A and 53B are likely come into contact with each other. If the protruding portion 23 and the fitting recessed portion 53 come into contact with each other in the vertical direction Z, for example, the positioning between the first positioning surface 21b and the attaching portion bottom surfaces 51aA and 51aB in the vertical direction Z, which is performed by the first pressing means 61 pressing the first positioning surface 21b against the attaching portion bottom surfaces 51aA and 51aB, may be disrupted. When the protruding portion 23 and the fitting recessed portions 53A and 53B have the shapes described above, it is possible to reduce a likelihood that such disruption will occur. That is, it is possible to suppress a decrease in positioning accuracy of the placement surface 21a in the vertical direction Z.

Also, the pedestal part 20 has the second positioning surface 22a that intersects the longitudinal direction X, the first attaching portion 50A has the first attaching portion side surface 52aA which is in contact (surface contact) with the second positioning surface 22a when the pedestal part 20 is attached, and the second attaching portion 50B has the second attaching portion side surface 52aB which is in contact (surface contact) with the second positioning surface 22a when the pedestal part 20 is attached. With this configuration, it is possible to easily perform the positioning between the placement surface 21a and the scratching blade 11 in the longitudinal direction X. Also, it is possible to attach the pedestal part 20 to the attaching portion 50A or 50B in a well-balanced manner in the longitudinal direction X. Therefore, it is possible to further improve the positioning accuracy of the placement surface 21a in the longitudinal direction X.

Also, in a state in which the scratching blade 11 is at a position to scratch the optical fiber F, the distance d2A between the first attaching portion side surface 52aA and the scratching blade 11 in a normal direction (longitudinal direction X) of the first attaching portion side surface 52aA is substantially equal to the distance d2B between the second attaching portion side surface 52aB and the scratching blade 11 in a normal direction (longitudinal direction X) of the second attaching portion side surface 52aB. With this configuration, in either case in which the pedestal part 20 is attached to the first attaching portion 50A or the second attaching portion 50B, it is possible to appropriately perform positioning between the placement surface 21a and the scratching blade 11 in the longitudinal direction X.

Also, the pedestal part 20 includes the second pressing means (second pressing part) 62 pressing the second positioning surface 22a against the first attaching portion side surface 52aA or the second attaching portion side surface 52aB when the pedestal part 20 is attached to the first attaching portion 50A or the second attaching portion 50B. With this configuration, it is possible to further improve the positioning accuracy of the placement surface 21a in the longitudinal direction X.

Also, the optical fiber cutting device 1 according to one or more embodiments further includes the waste bin part 40 having the accommodating space S is capable of accommodating fiber scraps generated from the optical fiber F and being attachable to either the first attaching portion 50A or the second attaching portion 50B. With this configuration, it is possible to further improve the usability of the optical fiber cutting device 1.

Also, the waste bin part 40 includes the third pressing means (third pressing part) 63 pressing the waste bin part 40 against the first attaching portion 50A or the second attaching portion 50B when the waste bin part 40 is attached to the first attaching portion 50A or the second attaching portion 50B. With this configuration, it is possible to easily perform the positioning of the waste bin part 40.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, if the placement surface 21a and the clamping surface 12a are parallel to each other when the first positioning surface 21b and the attaching portion bottom surface 51a are in contact with each other, the first positioning surface 21b may not be parallel to the placement surface 21a, and the attaching portion bottom surface 51a may not be parallel to the clamping surface 12a. For example, the normal to the first positioning surface 21b and the normal to the attaching portion bottom surface 51a may be inclined with respect to the vertical direction Z. However, a configuration in which the first positioning surface 21b and the placement surface 21a are parallel (the attaching portion bottom surface 51a and the clamping surface 12a are parallel) has an advantage that positioning is more easily performed than a configuration in which they are non-parallel. Specifically, since it is possible to suppress the first positioning surface 21b and the attaching portion bottom surface 51a being provided to be inclined with respect to each other, it is possible to suppress gravity in the inclined direction acting on the pedestal part 20. Therefore, it is possible to stably dispose the first positioning surface 21b on the attaching portion bottom surface 51a compared to a case in which the first positioning surface 21b and the attaching portion bottom surface 51a are provided to be inclined with respect to each other.

Also, the protruding portion 23 may not need to protrude in the longitudinal direction X as long as it is possible to achieve positioning between the placement surface 21a and the clamping surface 12a in the cross direction Y. For example, the protruding portion 23 may be provided on a lower surface of the placement portion 21, and the protruding portion 23 may protrude in the vertical direction Z (the second direction being a direction intersecting the placement surface 21a among the attaching directions in which the pedestal part 20 is attached to the first attaching portion 50A or the second attaching portion 50B). As long as it is a direction intersecting the cross direction Y, the direction in which the protruding portion 23 protrudes may be changed as appropriate. However, a configuration in which the protruding portion 23 protrudes in the longitudinal direction X has an advantage that positioning is more easily performed than a configuration in which the protruding portion 23 protrudes in other directions.

Also, the optical fiber cutting device 1 may not need to include the waste bin part 40.

Also, as long as it is possible to press the first positioning surface 21b against the attaching portion bottom surface 51a, the first pressing means 61 may not need to be a screw, and types of the first pressing means 61 may be changed as appropriate. For example, the first pressing means 61 may be a magnet or the like. Similarly, as long as it is possible to press the second positioning surface 22a against the attaching portion side surface 52a, types of the second pressing means 62 may be changed as appropriate. As long as it is possible to press the third positioning surface 41c against the attaching portion side surface 52a, types of the third pressing means 63 may be changed as appropriate.

Also, the pedestal part 20 (or the fiber holder 30 or the waste bin part 40) and the main body part 10 may each include a communication unit, and communication for authentication may be performed between the pedestal part 20 (the fiber holder 30 or the waste bin part 40) and the main body part 10. Also, the optical fiber cutting device 1 may include an alarm unit that issues an alarm when the pedestal part 20 (or the waste bin part 40) is not correctly attached to the attaching portion 50.

Also, the optical fiber cutting device 1 may include only one attaching portion 50. Even in this case, it is possible to provide the optical fiber cutting device 1 in which it is possible to easily position the pedestal part 20 with respect to the main body part 10 (the scratching blade and the clamping surface 12a) by employing the pedestal part 20 and the attaching portion having features described in the embodiments described above.

In addition, the components in the above-described embodiments may be appropriately replaced with well-known components within a range not departing from the spirit of one or more embodiments, and the embodiments and modified examples described above may be appropriately combined.

### REFERENCE SIGNS LIST

1 Optical fiber cutting device
10 Main body part
11 Scratching blade
12 Clamp
12a Clamping surface
20 Pedestal part
21A First side edge portion
21B Second side edge portion
21a Placement surface
21b First positioning surface
22a Second positioning surface
30 Fiber holder
40 Waste bin part
50 Attaching portion (first attaching portion, second attaching portion)
51a Attaching portion surface (first attaching portion surface, second attaching portion surface)
52a Attaching portion side surface (first attaching portion side surface, second attaching portion side surface)
53 Fitting recessed portion (first fitting recessed portion, second fitting recessed portion)
61 First pressing part
62 Second pressing part
63 Third pressing part
X Longitudinal direction
Y Cross direction
S Accommodating space

1. An optical fiber cutting device comprising:
a pedestal part on which a fiber holder holding an optical fiber is disposed, and
a main body part including:
a scratching blade that scratches the optical fiber;
a first attaching portion to which the pedestal part is attached; and
a second attaching portion to which the pedestal part is attached, wherein
when the scratching blade is positioned to scratch the optical fiber;
the first attaching portion and the second attaching portion are positioned on opposite sides from each other with respect to the scratching blade, and
the first attaching portion, the scratching blade, and the second attaching portion are arranged in a specific direction.

2. The optical fiber cutting device according to claim 1, wherein
the pedestal part has a placement surface on which the fiber holder is disposed,
the main body part further includes a clamp that clamps the optical fiber,
the clamp has a clamping surface that supports the clamped optical fiber,
the placement surface is substantially parallel to the clamping surface when the pedestal part is attached to the first attaching portion and when the pedestal part is attached to the second attaching portion, and
a distance between the placement surface and the clamping surface when the pedestal part is attached to the first attaching portion is substantially equal to a distance between the placement surface and the clamping surface when the pedestal part is attached to the second attaching portion.

3. The optical fiber cutting device according to claim 2, wherein
the pedestal part further has a positioning surface parallel to the placement surface,
the first attaching portion has a first attaching portion surface parallel to the positioning surface,
the second attaching portion has a second attaching portion surface parallel to the positioning surface,
the positioning surface and the first attaching portion surface are in surface contact when the pedestal part is attached to the first attaching portion, and
the positioning surface and the second attaching portion surface are in surface contact when the pedestal part is attached to the second attaching portion.

4. The optical fiber cutting device according to claim 3, wherein the pedestal part includes pressing part that presses the positioning surface against:
the first attaching portion surface when the pedestal part is attached to the first attaching portion, and
the second attaching portion surface when the pedestal part is attached to the second attaching portion.

5. The optical fiber cutting device according to claim 3, wherein the pedestal part further has one or more additional positioning surfaces.

6. The optical fiber cutting device according to claim 5, wherein the pedestal part includes:
a first side edge portion on a side in a cross direction intersecting a direction in which the pedestal part is attached to the first attaching portion or the second attaching portion; and
a second side edge portion on a side opposite to the first side edge portion in the cross direction, and
the pedestal part further has the positioning surface on the first side edge portion and one of the one or more additional positioning surfaces on the second side edge portion.

7. The optical fiber cutting device according to claim 1, wherein
the pedestal part has a placement surface on which the fiber holder is disposed,
the pedestal part includes a protruding portion protruding in a first direction parallel to the placement surface or a second direction intersecting the placement surface, wherein the first direction and the second direction are attaching directions in which the pedestal part is attached to the first attaching portion or the second attaching portion,
the first attaching portion has a first fitting recessed portion into which the protruding portion is fitted when the pedestal part is attached, and
the second attaching portion has a second fitting recessed portion into which the protruding portion is fitted when the pedestal part is attached.

8. The optical fiber cutting device according to claim 2, wherein
the pedestal part includes a protruding portion protruding in a first direction parallel to the placement surface or a second direction intersecting the placement surface, wherein the first direction and the second direction are attaching directions in which the pedestal part is attached to the first attaching portion or the second attaching portion,
the first attaching portion has a first fitting recessed portion into which the protruding portion is fitted when the pedestal part is attached, and
the second attaching portion has a second fitting recessed portion into which the protruding portion is fitted when the pedestal part is attached.

9. The optical fiber cutting device according to claim 7, wherein
the protruding portion has a circular cross-sectional shape perpendicular to the first direction, and
the first fitting recessed portion or the second fitting recessed portion has an oval cross-sectional shape having a major axis extending in a direction intersecting the placement surface and being perpendicular to the first direction.

10. The optical fiber cutting device according to claim 2, wherein
the pedestal part further has a positioning surface intersecting a first direction parallel to the placement surface among attaching directions in which the pedestal part is attached to the first attaching portion or the second attaching portion,
the first attaching portion has a first attaching portion side surface which is in surface contact with the positioning surface when the pedestal part is attached, and
the second attaching portion has a second attaching portion side surface which is in surface contact with the positioning surface when the pedestal part is attached.

11. The optical fiber cutting device according to claim 10, wherein when the scratching blade is positioned to scratch the optical fiber, a distance between the first attaching portion side surface and the scratching blade in a normal direction of the first attaching portion side surface is substantially equal to a distance between the second attaching portion side surface and the scratching blade in a normal direction of the second attaching portion side surface.

12. The optical fiber cutting device according to claim 10, wherein the pedestal part includes a pressing part that presses pressing the positioning surface against:
the first attaching portion side surface when the pedestal part is attached to the first attaching portion, and
the second attaching portion side surface when the pedestal part is attached to the second attaching portion.

13. The optical fiber cutting device according to claim 1, further comprising:
a waste bin part, having an accommodating space that accommodates fiber scraps from the optical fiber, that is attached and to the first attaching portion or the second attaching portion.

14. The optical fiber cutting device according to claim 13, wherein the waste bin part includes a pressing part that presses the waste bin part against:
the first attaching portion when the waste bin part is attached to the first attaching portion, and
the second attaching portion when the waste bin part is attached to the second attaching portion.
